(19) United States
(12) Patent Application Publication
(10) Pub. No.: US 2001/0019786 A1
(43) Pub. Date: Sep. 6, 2001

(54) Magnetic recording medium and magnetic recording apparatus

(75) Inventor: Hiroyuki Ikeda, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Chemical Corporation, Tokyo (JP)

(21) Appl. No.: 09/749,473

(22) Filed: Dec. 28, 2000

(30) Foreign Application Priority Data
Dec. 28, 1999 (JP) 11-372319

(51) Int. Cl. G11B 5/66

(52) U.S. Cl. 428/694 TM

(57) ABSTRACT

A magnetic recording medium comprising a non-magnetic substrate and at least one magnetic recording layer formed on the substrate via at least one soft magnetic layer, wherein the surface roughness (Ra) of the magnetic recording medium is at most 50 Å, and the product (μmax×t) of the maximum permeability (μmax) and the thickness (t) of the soft magnetic layer is at least 1,000,000 (H·Å/m).

### BACKGROUND OF THE INVENTION

1. Field of the Invention

The present invention relates to a magnetic recording medium comprising a non-magnetic substrate and a magnetic recording layer formed thereon via a soft magnetic layer, and a magnetic recording apparatus for recording information on this magnetic recording medium by means of a magnetic head and for reading out the recorded signals. Particularly, it relates to an improvement of the characteristics of the soft magnetic layer of such a magnetic recording medium to provide a magnetic recording medium excellent in the surface smoothness of the magnetic recording layer and having a good noise characteristic while maintaining the high permeability of the soft magnetic layer, and a magnetic recording apparatus having a high recording density and low noise, employing such a magnetic recording medium.

2. Discussion of Background

A magnetic recording medium having at least one magnetic recording layer formed on a non-magnetic substrate is generally classified into a longitudinal recording medium having an easy axis in the plane of the substrate and a perpendicular recording medium having an easy axis in a perpendicular direction to the plane of the substrate. In either medium, the most basic construction is such that a magnetic layer is formed on a non-magnetic substrate, and an overcoat layer and a lubricant layer are formed thereon, and depending upon the particular purpose or desired properties, the magnetic recording layer may be made to have a multilayer structure, and further, a non-magnetic underlayer of e.g. Cr may be provided between the non-magnetic substrate and the magnetic layer for the purpose of controlling refining of crystals or alignment of crystal faces.

For a longitudinal recording medium, as an application of this basic construction, an under keepered medium has been proposed wherein a single homogeneous soft magnetic layer having a high permeability, so-called a keeper layer, is formed between the non-magnetic substrate and the magnetic recording layer formed on the non-magnetic substrate, to absorb a magnetic flux of a magnetic transition domain. Further, for a perpendicular recording medium, it is known to provide a single homogeneous soft magnetic layer also having a high permeability, so-called a back layer, under the magnetic recording layer. The role of this soft magnetic layer so-called a back layer, is to take out a perpendicular component of the magnetic field from the head or to prevent formation of an inverse magnetic field in the magnetic recording layer, and for this purpose, an alloy or the like composed mainly of NiFe is employed.

The above-mentioned soft magnetic layer so-called a keeper layer or a back layer (hereinafter referred to simply as the soft magnetic layer, for the purpose of the present invention) serves to stabilize the magnetization recorded in the magnetic recording layer or to more effectively take out a writing magnetic field from the head, by withdrawing a magnetic flux of a magnetic transition domain of the magnetic recording layer or a magnetic field from the head into the soft magnetic layer (such a phenomenon of withdrawing a magnetic field is called a yoke effect) by means of its high permeability.

However, in the case of a magnetic recording medium wherein a soft magnetic layer having an adequate yoke effect, is formed, and a magnetic recording layer is formed thereon, the surface property of the magnetic recording layer tends to be poor, and no magnetic recording medium has been obtained whereby the yoke effect of the soft magnetic layer is effective for the improvement of the recording/reproducing characteristics. For example, in a case where Permalloy or the like is employed for the soft magnetic layer, it has been necessary to make the soft magnetic layer as thick as at least 5,000 Å in order to obtain a sufficient yoke effect. If the soft magnetic layer of Permalloy or the like is made as thick as such a level, the surface property tends to be poor due to non-uniformity of the crystals in the soft magnetic layer, and consequently, the surface property of the magnetic recording layer formed on such a soft magnetic layer tends to be poor and accordingly, the surface property of the magnetic recording medium tends to be poor, whereby there has been a problem that the recording/reproducing characteristics are poor.

### SUMMARY OF THE INVENTION

To solve the above problems, the present invention proposes that in a magnetic recording medium comprising a non-magnetic substrate and at least one magnetic recording layer formed thereon via at least one soft magnetic layer, the soft magnetic layer is divided into a plurality of layers by separate layers. In such a manner, while maintaining the total thickness of the soft magnetic layers at a certain level, the surface smoothness of the magnetic recording medium can be improved. Thus, it is an object of the present invention to provide a magnetic recording medium wherein the soft magnetic layer has an adequate yoke effect, and the surface property of the magnetic recording medium is good to provide excellent recording/reproducing characteristics, and a magnetic recording apparatus employing such a magnetic recording medium, which has a high recording density and a low noise, whereby particularly when evaluated by means of a normalized noise spectrum, the noise characteristic is good.

The present invention provides a magnetic recording medium comprising a non-magnetic substrate and at least one magnetic recording layer formed on the substrate via at least one soft magnetic layer, wherein the surface roughness (Ra) of the magnetic recording medium is at most 50 Å, and the product (μmax×t) of the maximum permeability (μmax) and the thickness (t) of the soft magnetic layer is at least 1,000,000 (H·Å/m).

With the magnetic recording medium of the present invention, by the above-defined characteristics, the soft magnetic layer has a sufficient yoke effect, and the surface property of the magnetic recording medium is good, whereby noise is little, and particularly when evaluated by means of a normalized noise spectrum, the noise characteristic is good, whereby a magnetic recording medium excellent in the recording/reproducing characteristics, can be realized.

### BRIEF DESCRIPTION OF THE DRAWINGS:

FIG. 1 is a view illustrating a layer structure comprising one magnetic recording layer and one soft magnetic layer formed on a substrate.

FIG. 2 is a view illustrating a layer structure comprising one magnetic recording layer and five soft magnetic layers separated by separate layers.

FIG. 3 is a view illustrating the state of a magnetic field from a ring head when the ring head is employed for recording on a magnetic recording medium having no soft magnetic layer provided as a back layer.

FIG. 4 is a view illustrating the state of a magnetic field from a ring head when the ring head is employed for recording on a magnetic recording medium having a soft magnetic layer provided as a back layer.

FIG. 5 is a graph showing the results of measurements of the surface roughnesses of the magnetic disks prepared in Example 1 and Comparative Examples 1 to 3.

FIG. 6 is a graph showing the normalized noise spectra of the magnetic disks prepared in Example 1 and Comparative Examples 1 to 3.

In the Figures, reference numeral 1 represents a magnetic recording layer, 2 a soft magnetic layer, 3 a substrate, 4 a magnetic recording layer, 5 a soft magnetic layer 1, 6 a separate layer 1, 7 a soft magnetic layer 2, 8 a separate layer 2, 9 a soft magnetic layer 3, 10 a separate layer 3, 11 a soft magnetic layer 4, 12 a separate layer 4, 13 a soft magnetic layer 5, 14 a substrate, 15 a magnetic recording layer, 16 a substrate, 17 a magnetic head, 18 a head magnetic field, 19 a magnetic recording layer, 20 a soft magnetic layer, 21 a substrate, 22 a magnetic head and 23 a head magnetic field.

### DETAILED DESCRIPTION OF THE PREFERRED EMBODIMENTS

In the magnetic recording medium of the present invention, at least one magnetic recording layer is formed on a non-magnetic substrate via at least one soft magnetic layer, wherein the surface roughness (Ra) of the magnetic recording medium is at most 50 Å, and the product (μmax×t) of the maximum permeability (μmax) and the thickness (t) of the soft magnetic layer is at least 1,000,000 (H·Å/m), whereby a magnetic recording medium having a good noise characteristic can be obtained. FIG. 1 shows an example of a layer structure comprising one magnetic recording layer and one soft magnetic layer formed on a substrate.

If the surface roughness (Ra) of the magnetic recording medium exceeds 50 Å, there will be a problem such that the noise at the time of recording/reproduction tends to be large. With a view to lowering the noise at the time of recording/reproduction, the smaller the surface roughness (Ra) of the magnetic recording medium, the better. More preferably, it is at most 45 Å. From the viewpoint of lowering the noise at the time of recording/reproduction, there is no preferred lower limit in the surface roughness. However, practically, there will be a limit by e.g. the material or by the sputtering technique. At present, from about 7 to 8 Å is practically obtainable where the surface property is best.

If the product (μmax×t) of the maximum permeability (μmax) and the thickness (t) of the soft magnetic layer is less than 1,000,000 (H·Å/m), the soft magnetic layer is unable to show an adequate yoke effect, and when formed into a magnetic recording medium, no adequate effect for reducing the noise at the time of recording/reproducing will be obtained. In order to increase the yoke effect, the larger the product (μmax×t) of the maximum permeability (μmax) and the thickness (t), the better. More preferably, it is at least 1,500,000 (H·Å/m). From the viewpoint of increasing the yoke effect, there is no preferred upper limit for the product (μmax×t) of the maximum permeability (μmax) and the thickness (t). However, it is practically limited by the value of the maximum permeability of the soft magnetic material which can practically be used and the upper limit of the thickness of the soft magnetic layer which can practically be formed.

The following may be considered to be one of the reasons why the surface property of a magnetic recording layer formed on a soft magnetic layer tends to be poor.

For the above soft magnetic layer to have an adequate yoke effect, a certain thickness is required. For example, when an alloy composed mainly of NiFe is employed as the material for the soft magnetic layer, it is formed into a relatively thick uniform film having a thickness of a few thousands Å. However, probably due to the size of crystals constituting the soft magnetic layer, the surface property of the soft magnetic layer tends to be poor as the thickness increases. The surface property of a magnetic recording layer formed thereon tends to be accordingly poor, and consequently, the surface property of the resulting magnetic recording medium tends to be poor. For example, when a NiFe alloy is formed into a film having a thickness of 5,000 Å, the surface roughness Ra of a magnetic recording medium formed thereon will be at least 60 Å, whereby the noise characteristic as evaluated by means of a normalized noise spectrum will be poor. In order to improve the noise characteristic, it is necessary to solve such a problem that as the thickness of the soft magnetic layer increases, the surface roughness due to non-uniformity of the crystal structure tends to increase.

To solve such a problem, instead of continuously sputtering the entire thickness of the soft magnetic layer required to have a certain film thickness, all at once, the required thickness is divided into thinner thicknesses where the surface of each soft magnetic layer has not yet been roughened by non-uniformity of crystals. Such thinner soft magnetic layers are overlaid one on another to obtain a film structure having the predetermined total film thickness.

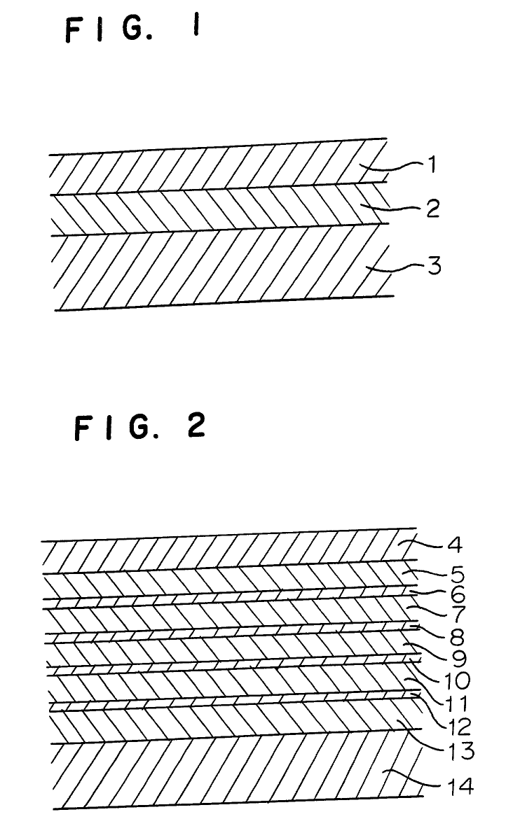

As a method for making the soft magnetic layer to have such a multilayer structure, the soft magnetic layer may be divided into a plurality of thin layers separated by other layers (separate layers) having a composition different from the composition of the soft magnetic layer (FIG. 2). If the thickness of the soft magnetic layer increases, there will be a drawback that the surface roughness increases due to e.g. non-uniformity of the crystal structure. To prevent such a drawback, it is necessary to control refinement of crystals and alignment of the crystal faces. For this purpose, a separate layer of e.g. a non-magnetic layer is provided to stop the crystal growth of the soft magnetic layer in a state where the crystal condition is good, and the surface is smooth. By making such a multilayer structure comprising soft magnetic layers and separate layers, a good surface property can be realized even if the total thickness of the soft magnetic layers is thick. With respect to the number of laminated layers of such soft magnetic layers and separate layers, it is preferred that the soft magnetic layers are from 2 to 20 layers. If the soft magnetic layer is one layer, the thickness tends to be too thick in order to let the soft magnetic layer have a necessary yoke effect, whereby the surface property of a magnetic recording layer formed thereon tends to be poor. If the soft magnetic layers exceed 20 layers, a process for alternately sputtering soft magnetic layers and separate layers, tends to be difficult, such being sometimes not practical.

With respect to the soft magnetic layer

For a soft magnetic layer to show a yoke effect of withdrawing a magnetic field from exterior, it is preferred that the soft magnetic layer is one which has a high permeability and which can be magnetically saturated. The coercive force of the soft magnetic layer is preferably small. If the coercive force is large, it may sometimes adversely affect the recorded signals of the magnetic recording layer. Preferably, it is at most 100 Oersted. The material to be preferably employed, may, for example, be a NiFe alloy (μmax=about 330 H/m), one having Mo incorporated to such a NiFe alloy, Supermalloy (μmax=about 1,000,000 H/m, coercive force=about 0.002 Oersted), Sendust, 78-Permalloy (μmax=about 100,000 H/m, coercive force=about 0.05 Oersted), a Mn—Zn ferrite (coercive force=about 0.1 Oersted), soft steel (μmax=about 2,000 H/m, coercive force=about 1.8 Oersted), nickel (μmax=about 600 H/m, coercive force=about 0.7 Oersted), or cobalt (μmax=about 250 H/M, coercive force=about 10 Oersted). The material which is practically most useful at present is a NiFe alloy or one having Mo incorporated thereto.

With respect to the separate layer

The separate layer has a composition different from the soft magnetic layer and has a role to separate the soft magnetic layer physically into a plurality of layers and to control the refinement and alignment of crystals in the separated soft magnetic layers. The material for such a separate layer is preferably a non-magnetic material, and non-magnetic Cr or Cr alloy is preferably employed.

Preferred combination and conditions of soft magnetic layers and separate layers

The total thickness of the plurality of soft magnetic layers and separate layers is preferably at least 500 Å. If the total thickness is less than 500 Å, no adequate yoke effect may sometimes be obtainable. The thicker the total thickness of the plurality of soft magnetic layers and separate layers, the larger the yoke effect. However, it is not practical to increase the total thickness by laminating so many soft magnetic layers and separate layers, as such lamination is cumbersome and time consuming. Usually, the total thickness is preferably at most 10,000 Å.

A preferred ratio of the total thickness of the plurality of soft magnetic layers and separate layers to the thickness of the separate layers, is from 1:0.05 to 1:0.5, more preferably from 1:0.07 to 1:0.2. If the ratio of the thickness of the separate layers is too small, the separation effect to improve the surface of the soft magnetic layer tends to be inadequate. On the other hand, if the ratio of the thickness of the separate layers is too large, the yoke effect tends to be inadequate.

The larger the maximum permeability of the soft magnetic layer, the better in order to accomplish the effects of the present invention. However, in reality, the upper limit is restricted by the type of material which can actually be used. At present, as a material having the largest maximum permeability which is practically useful, Supermalloy (μmax=1,000,000 H/m) may be mentioned.

The lower limit of the maximum permeability of the soft magnetic layer is restricted by the relation with the thickness so that the product of the maximum permeability and the thickness of the soft magnetic layer satisfies the condition of at least 1,000,000 H·Å/m, as a requirement of the present invention.

The thickness of each of the soft magnetic layers separated by a separate layer is preferably at most 4,000 Å, more preferably at most 1,500 Å. If the thickness of each of the soft magnetic layers separated by a separate layer is too thick, the surface roughness of each soft magnetic layer tends to be large, and even if a separate layer is provided, the surface property of the magnetic recording layer is likely to be poor.

Further, the thickness of each of the soft magnetic layers separated by a separate layer is preferably at least 100 Å, more preferably at least 300 Å. If the thickness of each of the soft magnetic layers is too thin, no adequate yoke effect tends to be obtainable.

The thickness of the separate layer is preferably at most 300 Å, more preferably at most 200 Å. If the thickness of the separate layer is too thick, the yoke effect tends to be inadequate in spite of the total thickness of soft magnetic layers and separate layers. Further, the thickness of the separate layer is preferably at least 10 Å, more preferably at least 50 Å. If the thickness of the separate layer is too thin, no adequate effect for improving the surface property of the soft magnetic layer may sometimes be obtainable.

In the case of a layer structure having a plurality of soft magnetic layers separated by separate layers, the thickness (t) of the soft magnetic layer to be used to obtain the product (μmax×t) of the maximum permeability (μmax) and the thickness (t) of the soft magnetic layer, is the total thickness of the plurality of soft magnetic layers not containing the separate layers.

With respect to the magnetic recording layer

The magnetic recording layer may, for example, be a Co alloy magnetic film, a rare earth type magnetic film represented by TbFeCo, a multilayer film of transition metal and noble metal type represented by a formed film of Co and Pd.

For the Co alloy magnetic film, pure Co or a Co alloy magnetic material which is commonly used as a magnetic material, such as CoNi, CoSm, CoCrTa, CoNiCr or CoCrPt, is usually employed. To such a Co alloy, an element such as Ni, Cr, Pt, Ta, W or B or a compound such as SiO₂ may further be incorporated. For example, CoCrPtTa, CoCrPtB, CoNiPt or CoNiCrPtB may be mentioned. The thickness of the Co alloy magnetic film is optional, but it is usually preferably at least 5 nm and at most 50 nm, more preferably at least 10 nm and at most 30 nm. Further, at least two such magnetic films may be laminated directly or via a proper non-magnetic interlayer. In such a case, the compositions of the magnetic materials to be formed may be the same or different.

For the rare earth type magnetic film, a rare earth magnetic material which is commonly employed as a magnetic material, such as TbFeCO, GdFeCO, DyFeCO or TbFe, is usually employed. Further, to such a rare earth alloy, Tb, Dy or Ho may, for example, be incorporated to form a four element type magnetic material, or for the purpose of preventing deterioration by oxidation, Ti, Al or Pt may be incorporated. The thickness of the rare earth type magnetic film is optional, but it is usually preferably at least 5 nm and at most 100 nm. Further, at least two such magnetic layers may likewise be formed directly or via a proper non-magnetic interlayer. In such a case, the compositions of the magnetic materials to be laminated may be the same or different. The rare earth type magnetic film is an amorphous structure film, whereby it is particularly suitable for high density recording, and the effect for reducing the noise by the present invention can be very much expected.

For the multilayer film of transition metal and noble metal type, a multilayer film material which is commonly employed as a magnetic material, such as Co/Pd, Co/Pt, Fe/Pt, Fe/Au or Fe/Ag, is usually employed. Such transition metal or the noble metal for such a multilayer film may not particularly be pure and may be an alloy composed mainly thereof. The thickness of the multilayer film is optional, but it is usually preferably at least 5 nm and at most 1,000 nm. Further, the manner of lamination is also optional, and it may not necessarily be a multilayer film of two materials.

With respect to application to perpendicular magnetic recording

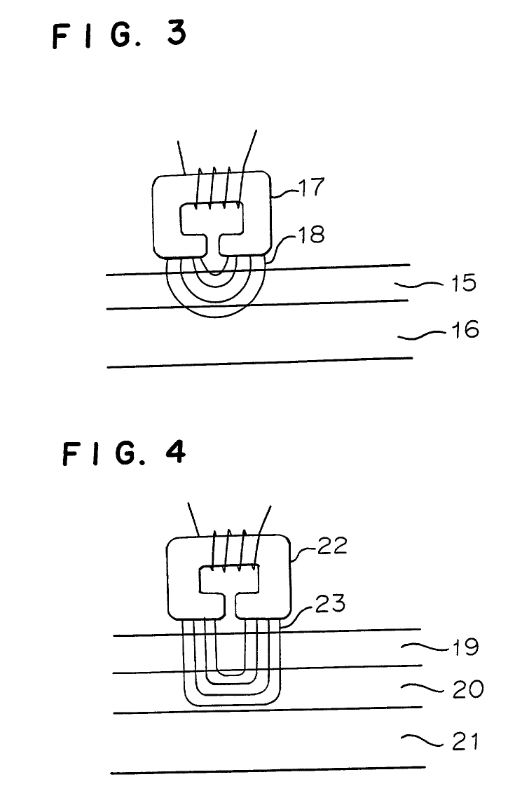

The soft magnetic layer of the present invention can be applied particularly suitably to a perpendicular magnetic recording medium wherein the magnetic recording layer has a perpendicular magnetic anisotropy. In the case of the perpendicular magnetic recording, it is necessary to efficiently take out a perpendicular component of magnetic field from a recording head. By providing a soft magnetic layer beneath the magnetic recording layer, the perpendicular component of magnetic field from the recording head will be enhanced to generate a head magnetic field suitable for perpendicular recording. This is schematically illustrated in FIG. 3 and FIG. 4 with respect to a case where a ring head is employed. FIG. 3 represents a case where no soft magnetic layer is present, and FIG. 4 represents a case where a soft magnetic layer is present. As shown in FIG. 4, in a case where a soft magnetic layer having high permeability is provided, the magnetic field from the ring head will be withdrawn into the soft magnetic layer by a yoke effect, whereby the perpendicular component of the magnetic field in the magnetic recording layer is enhanced as compared with the case where no soft magnetic layer is present as shown in FIG. 3. In the present invention, a larger yoke effect is imparted to the soft magnetic layer in order to further enhance the perpendicular component of the magnetic field from the recording head, whereby it is possible to obtain a magnetic recording medium which is more suitable for perpendicular magnetic recording.

With respect to the substrate

As the non-magnetic substrate for the magnetic recording medium of the present invention, any optional substrate may be employed so long as it is a non-magnetic substrate, for example, an Al alloy substrate containing Al as the main component, such as an Al—Mg alloy, a substrate made of usual soda glass, alumino silicate glass, silicon, titanium, ceramics or various resins, or a substrate made of a combination thereof. Among them, it is preferred to employ an Al alloy substrate or a substrate made of glass such as crystalline glass.

With respect to the process for the production

In the process for the production of the magnetic recording medium, it is common to firstly carry out washing and drying of the substrate. Also in the present invention, it is preferred to carry out washing and drying of the substrate prior to forming the respective layers in order to secure good adhesion of the respective layers.

Further, in the production of the magnetic recording medium of the present invention, a non-magnetic metal covering layer of e.g. NiP may be formed on the surface of the non-magnetic substrate. When such a non-magnetic metal covering layer is to be formed, a method commonly employed for forming a thin film may be employed such as an electroless plating method, a sputtering method, a vacuum vapor deposition method or a CVD method. In the case of a substrate made of a conductive material, an electroplating method may be employed. The thickness of the non-magnetic metal covering layer may be at least 50 nm, but taking into consideration the productivity of the magnetic recording medium, etc., it is preferably from 50 to 500 nm, particularly preferably from 50 to 300 nm.

The region for forming such a non-magnetic metal covering layer is preferably the entire region of the substrate surface. However, such a layer may be formed only on a part of the substrate surface, for example, only at a region where texturing as described hereinafter will be applied.

Further, concentric texturing may be applied to the substrate surface or to a substrate surface having a non-magnetic metal covering layer formed thereon. In the present invention, such concentric texturing means a state wherein a number of fine grooves are formed in the circumferential direction of the substrate by polishing in the circumferential direction by mechanical texturing employing free abrasive grains and a texture tape, or texturing by means of a laser beam, or by a combination thereof.

Here, as a type of free abrasive grains to be used for mechanical texturing, diamond abrasive grains, particularly those having the surface graphitized, are most preferred. Alumina abrasive grains are also widely used as abrasive grains to be used for mechanical texturing. However, from the viewpoint of the in-plane alignment medium whereby the easy axis is aligned along the texturing grooves, diamond abrasive grains will provide an extremely good performance. Although the mechanism is not clearly understood, the results with extremely good reproducibility have been obtained.

The effects of the present invention are not basically influenced by the surface roughness (Ra) of the substrate surface. However, for the realization of a high density magnetic recording, it is effective that the flying height of the head should be as small as possible, and one of the features of such a substrate resides in the excellent surface smoothness. Accordingly, Ra of the substrate surface is preferably at most 2 nm, particularly preferably at most 1 nm, most preferably at most 0.5 nm. Here, the determination of Ra is assumed to be made by measurement by means of a feeler-type surface roughness meter. Here, the forward end of the feeler for measurement has a radius of about 0.2 μm.

As described above, soft magnetic layers having separate layers are formed on a non-magnetic substrate subjected to washing, drying and if necessary, formation of a non-magnetic metal covering layer and concentric texturing. Here, the separate layers may be ones to separate the total thickness of the soft magnetic layer in equal distances or optional distances in thickness direction.

With respect to the underlayer

Further, in the present invention, in a case where the above non-magnetic metal covering layer is formed, an underlayer may be formed between the non-magnetic substrate and the above non-magnetic metal covering layer, or between the non-magnetic metal covering layer and the soft magnetic layer, or in a case where the non-magnetic metal covering layer is not formed, an underlayer may be formed between the non-magnetic substrate and the soft-magnetic layer. In such a case, this underlayer may be a film of the same material as or a different material from the separate layer to be formed between the adjacent soft magnetic layers, and it is preferably formed for the purpose of controlling refinement of crystals and alignment of the crystal faces. For both layers, a material containing Cr as the main component is preferred.

As the material for the underlayer containing Cr as the main component, it is possible to use pure Cr, or one having a second or third element such as V, Mo, Zr, Hf, Ta, W, Ge, Nb, Si, Cu or B added to Cr for the purpose of compatibility of crystallizability with the recording layer, or Cr oxide. Among them, pure Cr or one comprising Cr as the main component and one or more additional elements such as Ti, Mo, W, V, Ta, Si, Nb, Zr and Hf, is preferred. The optimum amounts of such second and third elements vary depending upon the respective elements. However, usually, they are within a range of from 1 to 50 atomic %, preferably from 5 to 30 atomic %, more preferably from 5 to 20 atomic %.

When an underlayer is to be formed, the thickness may be of a level sufficient to provide the anisotropy, and it is usually from 0.1 to 50 nm, preferably from 0.3 to 30 nm, more preferably from 0.5 to 10 nm. At the time of forming the underlayer containing Cr as the main component, heating of the substrate may or may not be carried out.

With respect to an overcoat layer and a lubricant layer

In a usual case, an optional overcoat layer is formed on the magnetic recording layer, and then a lubricant layer is formed thereon. For the overcoat layer, it is possible to employ a carbonaceous layer such as C, hydrogenated C, nitrogenated C, amorphous C or SiC, or an overcoat layer material which is commonly used, such as SiC₂, Zr₂O₃ or TiN. Further, the overcoat layer may be constituted by two or more layers. The thickness of the overcoat layer is preferably from 1 to 50 nm, particularly preferably from 5 to 30 nm. The lubricant to be used for the lubricant layer may, for example, be a fluorine type lubricant or a mixture thereof. The lubricant layer is usually formed in a thickness of from 1 to 4 nm.

With respect to the film-forming conditions

The film-forming method for forming the respective layers of the magnetic recording medium of the present invention is optional. For example, a direct current (magnetron) sputtering method, a high frequency (magnetron) sputtering method, an ECR sputtering method or a physical vapor deposition method such as a vacuum vapor deposition method, may be mentioned.

Further, there is no particular restriction as to the film forming conditions, and the ultimate vacuum, the system for heating the substrate, the substrate temperature, the pressure of the sputtering gas, the bias voltage, etc., may suitably be determined depending upon the film-forming apparatus. For example, in the case of sputtering, usually, the ultimate vacuum is at most 5×10⁻⁶ Torr, the substrate temperature is from room temperature to 400° C., the pressure of the sputtering gas is from 1×10⁻³ to 20×10⁻³ Torr, and the bias voltage is usually from 0 to −500V.

When the non-magnetic substrate is heated for film forming, the heating may be carried out before formation of the underlayer, or in a case where a transparent substrate having a low heat absorption, is to be used, in order to increase the heat absorption, an undercoat layer containing Cr as the main component or an underlayer having a B₂ crystal structure, may be formed, followed by heating of the substrate, and then the soft magnetic layer and the magnetic recording layer may be formed.

In a case where the magnetic recording layer is a rare earth type magnetic film, with a view to preventing corrosion or oxidation, it is preferred to adopt a method wherein the innermost and outermost peripheries of the disk are preliminarily masked, and multilayer film-formation up to the magnetic recording layer is carried out, and at the time of the subsequent film formation of an overcoat layer, the mask is removed, and the magnetic recording layer is completely covered by the overcoat layer, or in a case where there are two overcoat layers, up to the magnetic recording layer and the first overcoat layer may be formed as masked, and at the time of forming a second overcoat layer, the mask is removed, and the magnetic recording layer is likewise completely covered with the second overcoat layer, whereby corrosion and oxidation of the rare earth type magnetic layer can be prevented.

With respect to the magnetic recording apparatus

The magnetic recording apparatus of the present invention is a magnetic recording apparatus comprising at least such a magnetic recording medium of the present invention, a driving means to drive it in a recording direction, a magnetic head provided with a recording section and a reproducing section, a means to relatively move the magnetic head against the magnetic recording medium, and a recording/reproducing signal treating means to input recording signals to the magnetic head and to output reproducing signals from the magnetic head.

Here, by constituting the reproducing section of the magnetic head by a MR head, a sufficient signal intensity can be obtained even at a high recording density, and it is possible to realize a magnetic recording apparatus having a high recording density.

By combining a signal treating circuit by a maximum likelihood method, the recording density can further be improved. For example, sufficient S/N can be obtained even when recording/reproducing is carried out at a recording density of 2 G bits per square inch at a track density of at least 10 kTPI and at a linear recording density of at least 200 kFCI.

Further, by constituting the reproducing section of the magnetic head by a GMR head comprising a plurality of conductive magnetic layers whereby mutual magnetization directions are relatively changed by an external magnetic field to create a substantial change in resistance, and conductive non-magnetic layers disposed between such conductive magnetic layers, or by a GMR head utilizing a spin valve effect, it is possible to further increase the signal intensity, and it is possible to realize a magnetic recording apparatus having a high reliability with a linear recording density of at least 240 kFCI and with 3 G bits per square inch.

Now, the present invention will be described in further detail with reference to Examples and Comparative Examples. However, it should be understood that the present invention is by no means restricted by such specific Examples.

### EXAMPLE 1

An aluminosilicate type glass substrate having a diameter of 2.5 inches was washed and dried, and sequentially formed thereon were 1000 Å of Ni50Fe50 (Ni:Fe=50:50 in atomic ratio) formed under such conditions that the ultimate vacuum: 1.2×10⁻⁶ Torr, the substrate temperature: room temperature, the pressure of sputtering gas: Ar, 3×10⁻³ Torr, and the bias voltage: 0V, then, 100 Å of Cr formed under the same conditions, 1,000 Å of Ni50Fe50, 100 Å of Cr, 1,000 Å of Ni50Fe50, 100 Å of Cr, 1,000 Å of Ni50Fe50, 100 Å of Cr, 1,000 Å of Ni50Fe50, 100 Å of Cr and 1,000 Å of Ni50Fe50, to form five soft magnetic layers via Cr separate layers thereby to obtain a soft magnetic layer having an apparent total thickness of 5,400 Å. On this soft magnetic layer, Tb20Fe68Co12 (Tb:Fe:Co=20:68:12 in atomic ratio) was formed in a thickness of 300 Å as a magnetic recording layer, and with respect to the overcoat layer, Cr was formed in a thickness of 200 Å as a first overcoat layer, and sputter C was formed in a thickness of 50 Å as a second overcoat layer. Further, as a lubricant layer, a fluorine type lubricant was coated in a thickness of 1.5 nm thereon, followed by baking at 100° C. for 40 minutes to obtain a magnetic disk. The maximum permeability of the Ni50Fe50 soft magnetic layer formed under the above conditions, was 330 (H/m). The maximum permeability of the soft magnetic layer was obtained in such a manner that a B-H loop was measured by VSM (V.S. Magnetometer, manufactured by Riken Denshi K.K.) exclusive for a soft magnetic material, and among tangent lines at various points of the B-H loop, one having the maximum inclination was determined, and the maximum permeability was obtained from the inclination. From the total thickness of Ni50Fe50 i.e. 5,000 Å and the maximum permeability i.e. 330 H/m, the product of the maximum permeability and the thickness of the soft magnetic layer i.e. 1,650,000 H·Å/m, was obtained.

For evaluation of the surface smoothness of the obtained magnetic disk, the roughness within a range of 10 μm×10 μm of the disk surface was measured by AFM (Atomic Force Microscopy), and the Ra value was obtained.

Further, for evaluation of the noise of the magnetic recording medium, a signal of 82.3 MHz was written by means of Guzik, and the noise was evaluated by using a normalized noise spectrum having the noise at that time normalized by the square of the output value. Good or bad of the noise characteristic of the magnetic recording medium was represented by the frequency at which the normalized noise value exceeds 1×10 ⁻⁹. The lower the frequency, the better the noise characteristic of the magnetic recording medium.

### COMPARATIVE EXAMPLE 1

A magnetic disk was prepared in the same manner as in Example 1 except that Ni50Fe50 was continuously formed in a thickness of 5,000 Å without forming separate layers to divide the soft magnetic layer, and evaluation was carried out in the same manner.

### COMPARATIVE EXAMPLE 2

A magnetic disk was prepared in the same manner as in Example 1 except that Ni50Fe50 was continuously formed in a thickness of 3,000 Å without forming separate layers to divide the soft magnetic layer, and evaluation was carried out in the same manner.

### COMPARATIVE EXAMPLE 3

A magnetic disk was prepared in the same manner as in Example 1 except that Ni50Fe50 was continuously formed in a thickness of 1,000 Å without forming separate layers to divide the soft magnetic layer, and the evaluation was carried out in the same manner.

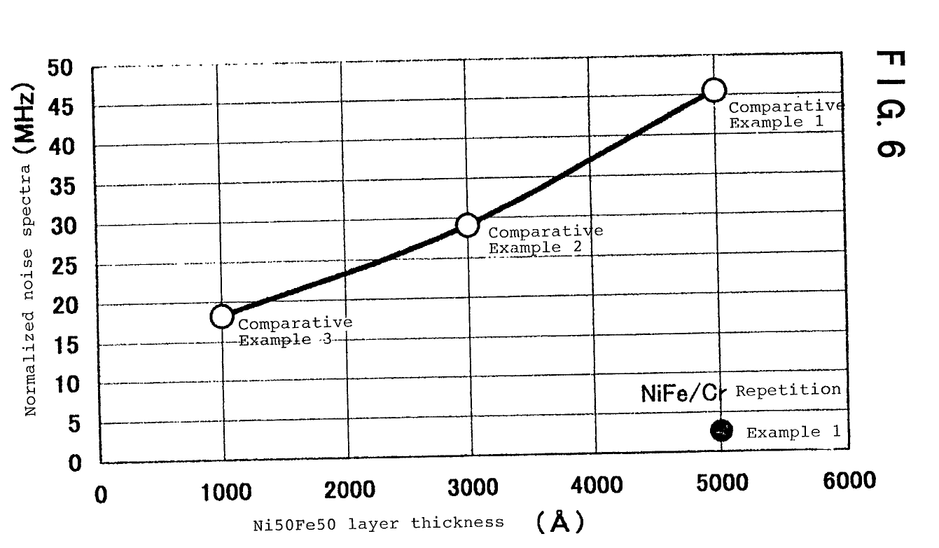

The evaluation results are summarized in Table 1. FIG. 6 shows the relation between the thickness of Ni50Fe50 and the surface roughness Ra of the magnetic disk, and FIG. 7 shows the relation between the thickness of Ni50Fe50 and the normalized noise spectrum.

TABLE 1

| | | Thickness | Maximum | Normalized |
|---|---|---|---|---|
| | Surface | of | permeability × | noise |
| | roughness: | Ni50Fe50 | Thickness | spectrum |
| | Ra (ÅA) | (Å) | (H · Å/m) | (MHz) |
| Example 1 | 42 | 5000 | 1,650,000 | 3 |
| Comparative | 67 | 5000 | 1,650,000 | 45 |
| Example 1 | | | | |
| Comparative | 39 | 3000 | 990,000 | 29 |
| Example 2 | | | | |
| Comparative | 24 | 1000 | 330,000 | 18 |
| Example 3 | | | | |

As is evident form Table 1, in Example 1 wherein both the surface property of the magnetic recording medium and the product of the thickness and the maximum permeability of the soft magnetic layer, satisfy the requirement of the present invention, the normalized noise spectrum shows a good value. In a case where either the surface property of the magnetic recording medium or the product of the thickness and the maximum permeability of the soft magnetic layer does not satisfy the requirement, the normalized noise spectrum deteriorates substantially.

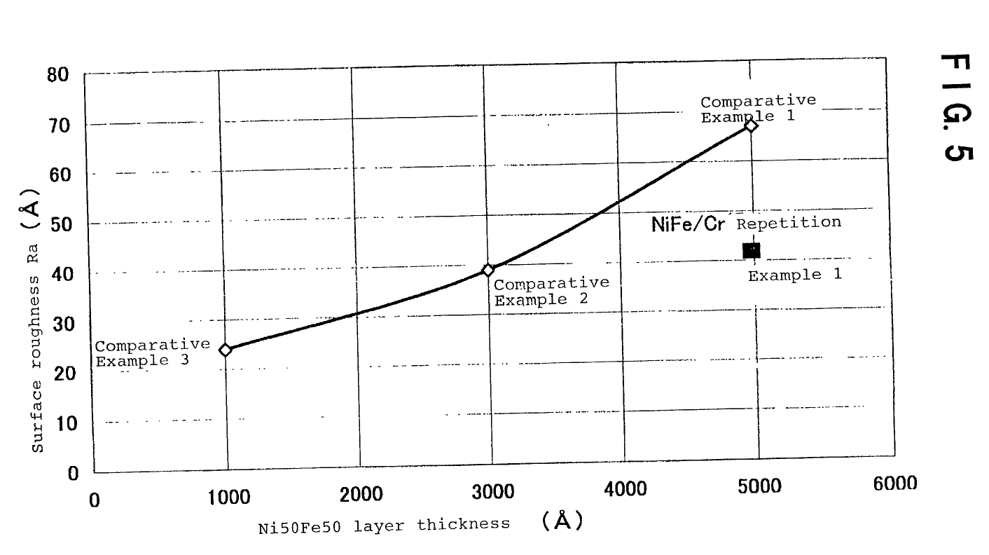

Further, from FIGS. 5 and 6, the following is apparent.

Namely, in a case where Ni50Fe50 is continuously formed in a single layer as a soft magnetic layer, the surface property deteriorates as the thickness increases. Whereas, as in Example 1, when separate layers are formed between soft magnetic layers, even when the thickness of the soft magnetic layers is such that the thickness of Ni50Ni50 only is 5,000 Å and the apparent total thickness including the separate layers is 5,400 Å, the same surface roughness as in a case where Ni50Fe50 is continuously formed in a single layer in a thickness of 3,000 Å, can be obtained.

Further, also with respect to the noise spectrum, in a case where Ni50Fe50 is continuously formed in a single layer as a soft magnetic layer, the frequency exceeding 1×10⁻⁹ tends to shift towards the high frequency side, and the noise tends to increase, as the thickness increases. Whereas, with the soft magnetic layers in Example 1 having separate layers formed therebetween, even when the thickness of Ni50Fe50 only is 5,000 Å, and the apparent total thickness including separate layers is 5,400 Å, the frequency tends to shift towards the low frequency side, and the noise tends to be small as compared with a case where Ni50Fe50 is continuously formed in a single layer in a thickness of 1,000 Å.

From the foregoing results, it is evident that to interpose separate layers between a plurality of soft magnetic layers, is an effective method to obtain a magnetic recording medium having a good surface property, a large value of the product of the thickness and the maximum permeability of the soft magnetic layer and a good noise characteristic.

As described in detail in the foregoing, the present invention provides a magnetic recording medium comprising a non-magnetic substrate and at least one magnetic recording layer formed thereon via a soft magnetic layer as a keeper layer or a back layer, wherein the soft magnetic layer is formed so as to provide a sufficient yoke effect, and the surface property of the magnetic recording medium is good, whereby a magnetic recording medium having a good noise characteristic, and a magnetic recording apparatus with a low noise and a high recording density employing such a magnetic recording medium, can be presented.

What is claimed is:

1. A magnetic recording medium comprising a non-magnetic substrate and at least one magnetic recording layer formed on the substrate via at least one soft magnetic layer, wherein the surface roughness (Ra) of the magnetic recording medium is at most 50 Å, and the product (μmax×t) of the maximum permeability (μmax) and the thickness (t) of the soft magnetic layer is at least 1,000,000 (H·Å/m)

2. The magnetic recording medium according to claim 1, wherein a plurality of soft magnetic layers are present, and a separate layer is provided between the adjacent soft magnetic layers.

3. The magnetic recording medium according to claim 1, which has from 2 to 20 soft magnetic layers, and a separate layer is provided between the adjacent soft magnetic layers.

4. The magnetic recording medium according to claim 2, wherein the total thickness of the plurality of soft magnetic layers and separate layers is from 500 to 10,000 Å.

5. The magnetic recording medium according to claim 2, wherein the ratio of the total thickness of the plurality of soft magnetic layers and separate layers to the thickness of the separate layers, is from 1:0.05 to 1:0.5.

6. The magnetic recording medium according to claim 2, wherein the ratio of the total thickness of the plurality of soft magnetic layers and separate layers to the thickness of the separate layers, is from 1:0.07 to 1:0.2.

7. The magnetic recording medium according to claim 2, wherein the separate layers are non-magnetic layers.

8. The magnetic recording medium according to claim 2, wherein the separate layers are Cr or an alloy containing Cr as the main component.

9. The magnetic recording medium according to claim 2, wherein the thickness of separate layers is from 50 to 300Å.

10. The magnetic recording medium according to claim 1, wherein the maximum permeability of the soft magnetic layer is from 10 to 1,000,000 H/m.

11. The magnetic recording medium according to claim 1, wherein the coercive force of the soft magnetic layer is at most 100 Oersted.

12. The magnetic recording medium according to claim 1, wherein the soft magnetic layer is made of a NiFe alloy or a NiFeMo alloy.

13. The magnetic recording medium according to claim 1, which is a perpendicular magnetic recording medium.

14. A magnetic recording apparatus comprising a magnetic recording medium, a driving means to drive the magnetic recording medium in a recording direction, a magnetic head provided with a recording section and a reproducing section, a means to relatively move the magnetic head against the magnetic recording medium, and a recording/reproducing signal treating means to input recording signals to the magnetic head and to output reproducing signals from the magnetic head, wherein the magnetic recording medium is a magnetic recording medium as defined in claim 1.
